(19) United States
(12) Patent Application Publication
(10) Pub. No.: US 2013/0239998 A1
(43) Pub. Date: Sep. 19, 2013

(54) Gas Distributor Fitting and Method for Controlling the Gas Distribution for Cleaning Immersed Filter Elements

(71) Applicants: Martin Brockmann, Lengerich (DE); Jurgen Kunzel, Marl (DE); Heribert Moslang, Meerbusch (DE); Norbert Wegmann, Walchum (DE)

(72) Inventors: Martin Brockmann, Lengerich (DE); Jurgen Kunzel, Marl (DE); Heribert Moslang, Meerbusch (DE); Norbert Wegmann, Walchum (DE)

(73) Assignee: AQUANTIS GmbH, Ratingen (DE)

(21) Appl. No.: 13/988,115

(22) PCT Filed: Nov. 30, 2011
(86) PCT No.: PCT/EP2011/005998

§ 371 Date: May 17, 2013

(30) Foreign Application Priority Data
Dec. 3, 2010 (DE) 10 2010 053 180.4

(51) Int. Cl. B08B 3/10

(52) U.S. Cl. CPC B08B 3/10
USPC 134/37; 137/862

(57) ABSTRACT

The invention relates to a fitting for distributing a gas flow to two or more flow ducts, wherein the fitting has an inlet connecting piece (20) and two or more separate outlet connecting pieces (21, 22), wherein upstream of each outlet connecting piece (21, 22) there is arranged a disc valve, wherein the disc valve inserts (15, 16) of two or more disc valves are kinematically coupled, and to a method for cleaning filter elements (4) immersed in a basin (1), in particular diaphragm filters, by aeration of the filter elements by means of gas bubbles which are introduced into the basin (1) below the filter elements (4) via aerators (5), wherein a gas flow for aerating the filter elements (4) is generated by means of a blower (7), wherein the gas flow is distributed by means of a fitting to two or more aerators (5), wherein the distribution of the gas flow takes place discontinuously, such that a pulsed aeration of the filter elements (4) of varying duration takes place at irregular intervals.

The invention relates to a fitting for distributing a gas flow to two or more flow ducts, whereby the fitting has an inlet connecting piece and two or more separate outlet connecting pieces.

The invention further relates to a method for cleaning filter elements immersed in a basin, in particular diaphragm filters, by an aeration of filter elements by means of gas bubbles, which are introduced into the basin below the filter elements via aerators, whereby a gas flow for aerating the filter elements is generated by means of a blower.

Such manifold valves are known. It is also known to clean filter systems in immersed design for the solid-liquid and liquid-liquid separation by means of gas bubbles (for the most part air), i.e., the liquid/gas two-phase flow is used for the flushing of solids from the filter surface and thus for the deconcentration of solids in the immediate vicinity of the filter. The gas is usually compressed by a blower and incorporated into the medium via so-called aerators in the lower area of the filter.

The amount of gas that is necessary for the efficient cleaning of solids from the filter surface determines the energy consumption for the blower. This energy consumption constitutes a significant portion of the operating costs for the filter system.

Other designs recommend loading multiple aerators alternately with gas, whereby a constant amount of gas is supplied by the blower, and said gas then is distributed to individual aerators at regular intervals (e.g., every 10 seconds). For the gas distribution, in this case for the most part pneumatically-driven disk valves, so-called air-cycling valves, are used, which are alternately opened and closed. As a result, the filter elements are alternately loaded with gas over a certain period, followed by an equal period without aeration.

In this case, it is disadvantageous that the so-called air-cycling valves have a high frequency of operation of in part over 3 million switching operations annually and are therefore subject to a high wear and tear. Also, they have a significant requirement for compressed air, which very negatively affects the consumption of energy.

The object of the invention is to further develop a fitting as well as a method for cleaning filter elements of the above-mentioned type that are immersed in a basin in such a way that the above-mentioned drawbacks of the state of the art are overcome and in particular an effective cleaning of immersed filter elements in an optimized energy consumption is made possible. Also, a fitting with a longer service life is to be provided.

This object is achieved according to the invention by a fitting according to Claim 1 as well as a method according to Claim 7. Advantageous further developments of the invention are indicated in the respective subclaims.

In the fitting according to the invention for distributing a gas flow to two or more flow ducts, whereby the fitting has an inlet connecting piece and two or more separate outlet connecting pieces, it is especially advantageous that a disk valve is arranged upstream from each outlet connecting piece, whereby the disk valve inserts of two or more disk valves are kinematically coupled.

In this connection, a distribution of the gas flow to two or more flow ducts, which are connected to the two or more outlet connecting pieces of the fitting, is possible, whereby a simplified actuation as well as less wear and tear result by the kinematic coupling of the disk valve inserts. In this case, opening and closing the outlet connecting pieces is preferably carried out by a simple rotation of the disk valve inserts around an axis perpendicular to the direction of flow.

Preferably, the disk valve inserts of two or more disk valves can be coupled together by a belt, in particular a toothed belt or V-belt, etc.

Alternatively, the disk valve inserts of two or more disk valves are coupled together via external teeth.

In this connection, a kinematic coupling of two or more disk valve inserts can be achieved by simple means by standardized components, which makes possible reasonably-priced production and assembly.

In a preferred embodiment, the disk valve inserts of two disk valves have a relative angle of rotation offset of 60° to 120°, in particular 90°, to one another.

By the especially preferred relative angle of rotation offset of 90° between two disk valve inserts, which in each case rotate around an axis that is perpendicular to the direction of flow and which are kinematically coupled below one another, an alternate loading of the two outlet connecting pieces is carried out, so that an optimized gas distribution and use of the available gas flow is provided.

In a preferred embodiment, the fitting has an electric motor for driving the disks of the disk valves in rotation, in particular an electric motor with variable speed.

Such an electric motor allows for a variation of the speed, from which the possibility of irregular and pulsed loading of the various outlet connecting pieces results. This allows for an especially advantageous application of the fitting in the method according to the invention for cleaning immersed filter elements.

In contrast to conventional disk valves, whose drive pneumatically produces a 90° movement for opening or closing, the drive of the fitting performs a rotational movement, which is transferred to the valve inserts. From this results a longer service life of the fitting, since frequent load variations do not take place but rather only rotational movements are carried out.

The disk valve inserts in this case can be formed by flat disks or by valve inserts, which are formed by sectors, in particular by sectors with an angle at center of up to 90°.

By using valve inserts formed by sectors, various trends in the opening and closing behavior of the disk valves can be produced; in particular, this allows for another energetic optimization of the consumption of prepared, compressed gas and thus an optimization of the energy consumption of the entire unit.

In this case, the term sector relates to the projection of the disk valve insert in the direction of the axis of rotation of the disk valve insert. In the direction of flow, the projection of the disk valve insert is always matched to the inside contour of the flow duct, which is preferably circular.

Preferably, the fitting has a blower, in particular a speed-regulated blower, for provision of the gas flow.

In the method for cleaning filter elements immersed in a basin, in particular diaphragm filters, by an aeration of filter elements by means of gas bubbles, which are introduced into the basin via aerators below the filter elements, whereby a gas flow for aerating the filter elements is generated by means of a blower, it is especially advantageous that the gas flow is distributed by means of a fitting, in particular by means of a fitting according to the invention, on two or more aerators, whereby the distribution of the gas flow is carried out intermittently, so that a pulsed aeration of the filter elements of varying duration is carried out at irregular intervals.

Preferably, the pulsed aeration is generated by means of a fitting according to the invention by an irregular variation of the speed of the disk valve inserts, in particular by a variation of the speed of an electric motor for driving the disk valve inserts in rotation at irregular intervals.

The drive of the disk valve inserts of the fitting does not in this case run at a constant speed. Rather, the speed of the drive is varied by a control unit at irregular intervals, in such a way that a pulsed aeration is produced that is not carried out at regular time intervals to be repeated within equal short periods.

It has been shown, surprisingly enough, that better cleaning results are achieved by such a pulsed, irregular aeration than with the known methods according to the state of the art. By the pulsed, non-cyclic aeration, the filters are especially efficiently cleaned. As a result, the gas consumption that is necessary for the filter cleaning can be reduced, and the requirement of energy for the compression of gas is reduced.

Known gas distributor fittings with pneumatically-driven open-shut disk valves according to the previously known state of the art are subject to very high wear and tear because of the high frequency of operation. The fitting according to the invention with the described rotary drive is not subject to any significant wear and tear. As a result, the operating safety of the filter systems is considerably increased. In this case, the energy requirement for the drive of the fitting is only a fraction of the energy necessary for the generation of compressed air for driving conventional disk valves.

Embodiments of the invention are shown in the figures and are explained in more detail below. Here:

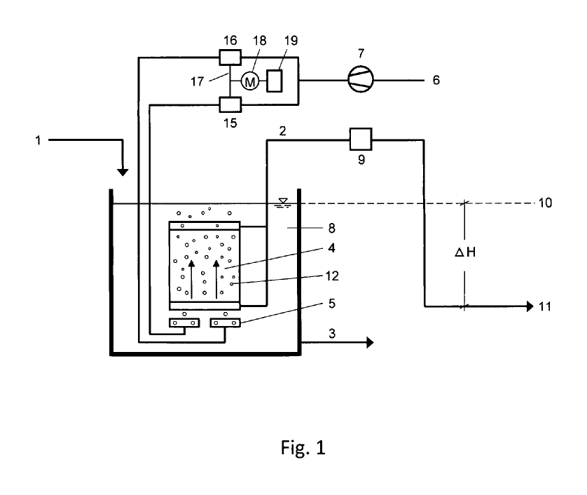

FIG. 1 shows an immersed diaphragm filter system with a fitting for distributing the air flow for aeration of the diaphragm filter elements for cleaning the diaphragm filter elements by means of irregular aeration;

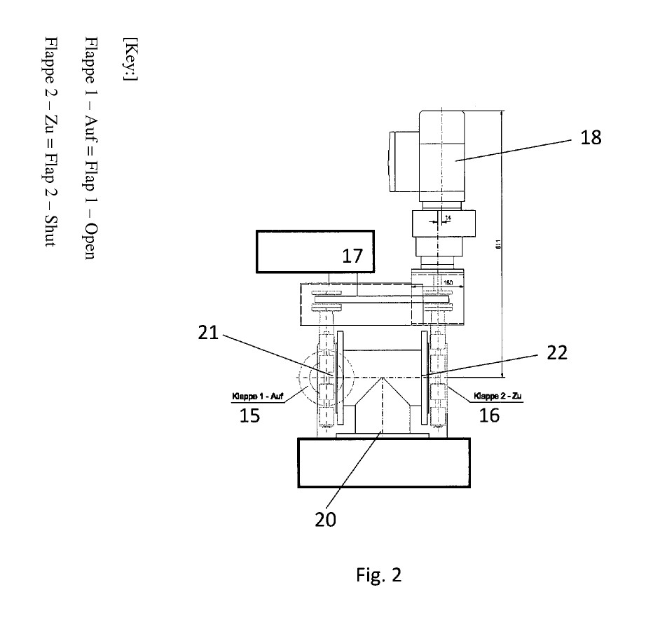

FIG. 2 shows a side view of a first embodiment of a fitting;

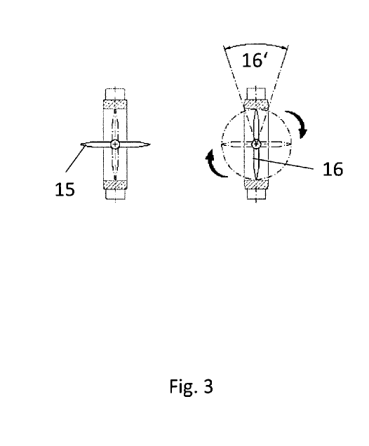

FIG. 3 shows a top view of the disk valve inserts of the fitting according to FIG. 2;

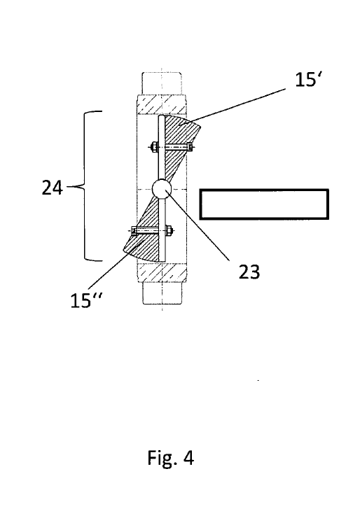

FIG. 4 shows a top view of a disk valve insert of a second embodiment of a fitting.

FIG. 1 shows an immersed diaphragm filter system with a fitting 15-19 to distribute the air flow for aeration of the diaphragm filter elements 4 for cleaning the diaphragm filter elements by means of irregular aeration.

The liquid that is to be filtered 1 is fed to a basin or tank 8. The immersed filter elements 4 are installed in the basin 8. The filtrate 2 is suctioned off from the system by underpressure that results from a pump 9 or a delta H water level difference between the filling level 10 in the basin 8 and the filtrate outlet 11.

The retentate 3 (the concentrated solid) is extracted from the tank 8 at another point.

So-called aerators 5 are installed below the filter elements 4. The gas 6 (air in the aerobic method) is compressed by means of a blower 7 and fed to the aerators 5. The rising gas bubbles 12 effect a cleaning of the filter elements in combination with the induced liquid flow.

The invention is essentially based on the gas distributor fitting 15-19, which distributes the amount of gas supplied by a continuously running blower 7 to individual aerators 5 and a control unit 19 that controls the drive 18 of the gas distributor fitting 15-19 in such a way that a pulsed aeration for the filter 4 is achieved by a variable drive speed. A cyclical switch-over at regular, short intervals between aeration and non-aeration is thus prevented.

The gas distributor fitting essentially consists of two modified disk valves 15, 16 that are connected to one another via a toothed belt 17 and are driven by an electric motor 18. The disk valve inserts are offset to one another at an angle of 90°.

In contrast to conventional disk valves, whose drive pneumatically produces a 90° movement for opening or closing, the drive of the gas distributor fitting performs a pure rotational movement, which is transferred to the valve inserts 15, 16.

In this case, the drive 18 of the gas distributor fitting does not run at constant speed. Rather, the speed of the drive 18 is varied by the control unit 19 at irregular intervals, in such a way that a pulsed aeration is produced, which thus does not take place at regular time intervals repeating in equal short periods.

The filters 4 are cleaned especially efficiently by the pulsed aeration. As a result, the gas consumption that is necessary for the filter cleaning can be reduced. Consequently, the energy requirement for the compression of gas is reduced.

The fitting according to the invention with the described rotary drive is not subject to any significant wear and tear. As a result, the operating safety of the filter systems is considerably increased. The energy requirement for the drive of the fitting is only a fraction of the energy necessary for the generation of compressed air for driving conventional disk valves.

In FIG. 2, the fitting with the electric-motor drive 18 is shown in a side view. The disk valve inserts 15, 16 are kinematically coupled via the toothed belt 17. The disk valves 15, 16 are in each case arranged upstream from one of the two outlet connecting pieces 21, 22. The air supply is done via the inlet connecting pieces 20 of the fitting.

The valve disk inserts 15, 16 of the fitting according to FIG. 2 is shown enlarged in FIG. 3. In the position pictured in FIGS. 2 and 3, the disk valve 15 is completely open, i.e., the flow cross-section of the outlet connecting pieces 21 is completely released so that the air flow is at a maximum in this position.

The second disk valve 16 is completely closed in this position, i.e., the flow cross-section of the outlet connecting piece 22 is completely covered by the disk insert 16, in such a way that the air flow is at a minimum in this position.

Also, the angle range 16′ of the flap positions, in which there is no air flow, is indicated in FIG. 3.

In FIG. 4, another flap design of a disk valve is shown. In this case, the flap is formed by two sectors 15′, 15″. The term sector 15′, 15″ in this case relates to the view perpendicular to the axis of rotation 23 of the disk valve insert within the flow cross-section 24 of the outlet connecting piece, as is shown in FIG. 4.

The axis of rotation 23 of the disk valve insert is perpendicular to the direction of flow. As a result of the disk valve insert in this embodiment being formed by sectors 15′, 15″, the angle, in which there is no air flow, is enlarged and thus the closing time in the outlet connecting piece is extended. In this connection, a further reduction of the air requirement is accomplished.

This is especially advantageous when multiple filter columns or filter routes are used in parallel since in actual units, often a large number of filter elements are arranged in parallel in order to be able to produce the required unit throughputs.

1. A fitting for distributing a gas flow to two or more flow ducts, whereby the fitting has an inlet connecting piece (20) and two or more separate outlet connecting pieces (21, 22) and a plurality of disk valves having disk valve inserts, characterized in that each disk valve is arranged upstream from each outlet connecting piece (21, 22), whereby the disk valve inserts (15, 16) of two or more disk valves are kinematically coupled.

2. A fitting according to claim 1, wherein the disk valve inserts (15, 16) of two or more disk valves are coupled together by a toothed belt (17) or V-belt.

3. A fitting according to claim 1, wherein the disk valve inserts (15, 16) of two or more disk valves are coupled together via external teeth.

4. A fitting according to claim 1, wherein the disk valve inserts (15, 16) of two disk valves have a relative angle of rotation offset of 60° to 120°, in particular 90°, to one another.

5. A fitting according to claim 1, wherein the fitting has an variable speed electric motor (18) for driving the disk valve inserts (15, 16) of the disk valves in rotation.

6. A fitting according to claim 1, wherein the disk valve inserts (15, 16) are formed by flat disks or by valve inserts, which are formed by sectors (15′, 15″), in particular by sectors with an angle at center of up to 90°.

7. A fitting according to claim 1, further comprising a speed-regulated blower, for provision of the gas flow.

8. A method for cleaning filter elements (4) immersed in a basin (1), in particular diaphragm filters, by an aeration of filter elements by means of gas bubbles, which are introduced into the basin (1) via aerators (5) below the filter elements (4), whereby a gas flow for aerating the filter elements (4) is generated by means of a blower (7), wherein the gas flow is distributed by means of a fitting said fitting comprising an inlet connecting piece (20) and two or more separate outlet connecting pieces (21, 22), and a plurality of disk valves having disk valve inserts, characterized in that each disk valve is arranged upstream from each outlet connecting piece (21, 22), whereby the disk valve inserts (15, 16) of two or more disk valves are kinematically coupled on two or more aerators (5), whereby the distribution of the gas flow is carried out intermittently, so that a pulsed aeration of the filter elements (4) of varying duration is carried out at irregular intervals.

9. The method according to claim 8, wherein the pulsed aeration is generated by an irregular variation of the speed of disk valve inserts (15, 16), by varying the speed of an electric motor (18) for driving the disk valve inserts (15, 16) in rotation at irregular intervals.

10. A fitting according to claim 3, wherein the fitting has a variable speed electric motor (18) for driving the disk valve inserts (15, 16) of the disk valves in rotation.

11. A fitting according to claim 3, wherein the disk valve inserts (15, 16) are formed by flat disks or by valve inserts, which are formed by sectors (15′, 15″), in particular by sectors with an angle at center of up to 90°.

12. A fitting according to claim 3 further comprising a speed-regulated blower for provision of the gas flow.

13. A fitting according to claim 4 wherein the fitting has a variable speed electric motor (18) for driving the disk valve inserts (15, 16) of the disk valves in rotation.

14. A fitting according to claim 4 wherein the disk valve inserts (15, 16) are formed by flat disks or by valve inserts, which are formed by sectors (15′, 15″), in particular by sectors with an angle at center of up to 90°.

15. A fitting according to claim 4 further comprising a speed-regulated blower for provision of the gas flow.

16. The method according to claim 8 wherein the disk valve inserts (15, 16) of two or more disk valves are coupled together by a toothed belt (17) or V-belt.

17. The method according to claim 9 wherein the disk valve inserts (15, 16) of two or more disk valves are coupled together by a toothed belt (17) or V-belt.

18. The method according to claim 8 wherein the disk valve inserts (15, 16) of two or more disk valves are coupled together via external teeth.

19. The method according to claim 9 wherein the disk valve inserts (15, 16) of two or more disk valves are coupled together via external teeth.
